(19) United States
(12) Patent Application Publication
(10) Pub. No.: US 2016/0112002 A1
(43) Pub. Date: Apr. 21, 2016

(54) ANTI-THEFT MOUNTING APPARATUS FOR SOLAR PANEL

(71) Applicant: Caterpillar Inc., Peoria, IL (US)

(72) Inventor: Tazio S. Grivetti, Chillicothe, IL (US)

(73) Assignee: Caterpillar Inc., Peoria, IL (US)

(21) Appl. No.: 14/979,611

(22) Filed: Dec. 28, 2015

(51) Int. Cl. H02S 30/10; F16M 13/02

(52) U.S. Cl. CPC H02S 30/10; F16M 13/02

(57) ABSTRACT

An anti-theft mounting apparatus for solar panel is provided. The anti-theft mounting apparatus includes a base layer of cementitious composite disposed at a target location and a fastening member for fastening the base layer of cementitious composite to the target location. The anti-theft apparatus further includes a damping member disposed on the base layer of cementitious composite and along a periphery of the solar panel. The anti-theft further includes a top layer of cementitious composite disposed on the damping member and along the periphery of the solar panel. The top layer of cementitious composite binds with the base layer of cementitious composite to form an anti-theft coupling.

### TECHNICAL FIELD

The present disclosure relates to mounting of solar panels, and more particularly to an anti-theft mounting apparatus for solar panels.

### BACKGROUND

Typically, photovoltaic modules, such as a solar panel, convert incident sunlight into electrical power. The solar panels, generally, are available in thin sheets of a rigid material, such as glass, plastic, metal, or a combination thereof. A number of such solar panels are arranged into arrays and mounted on a target location, such as a roof of a building or a roof of a vehicle. The solar panels are relatively expensive and are thus subjected to misappropriation and theft. Therefore, the solar panels need to be securely mounted to the target location in a manner, such that any misappropriation or any attempt to un-mount the solar panels from the target location is prevented.

Chinese Patent Application number 102544145, hereinafter referred to as the '145 application, discloses a solar energy bracket and a method of preventing solar energy photovoltaic plate from being stolen. The solar energy bracket includes a means for wrapping the solar energy photovoltaic panel and an inner surface of a bonding is disposed on the solar energy photovoltaic panel. The bracket includes a plurality of connectors disposed for supporting the solar energy photovoltaic panel surface, composed by a number of beams. Bolted connections are provided through the beam for supporting photovoltaic panels and pillars bearing surface. The bearing surface fixed on the pillars at each connection bracket also use anti-theft bolts.

### Summary of the Disclosure

In one aspect of the present disclosure, an anti-theft mounting apparatus for a solar panel is provided. The anti-theft mounting apparatus includes a base layer of cementitious composite disposed at a target location. The anti-theft mounting apparatus further includes a fastening member for fastening the base layer of composite to the target location. The anti-theft mounting apparatus further includes a damping member disposed on the base layer of cementitious composite and along a periphery of the solar panel. The anti-theft mounting apparatus further includes a top layer of cementitious composite disposed on the damping member and along the periphery of the solar panel. The top layer of cementitious composite binds with the base layer of cementitious composite to form an anti-theft coupling.

Other features and aspects of this disclosure will be apparent from the following description and the accompanying drawings.

### BRIEF DESCRIPTION OF THE DRAWINGS

FIG. 1 is a perspective view of a solar panel set mounted at a target location using an anti-theft mounting apparatus, according to an embodiment of the present disclosure;

FIG. 2 is a partial sectional view of the solar panel set of FIG. 1 taken along a line X-X′; and

FIG. 3 is a flowchart of a method for mounting the solar panel set at the target location.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

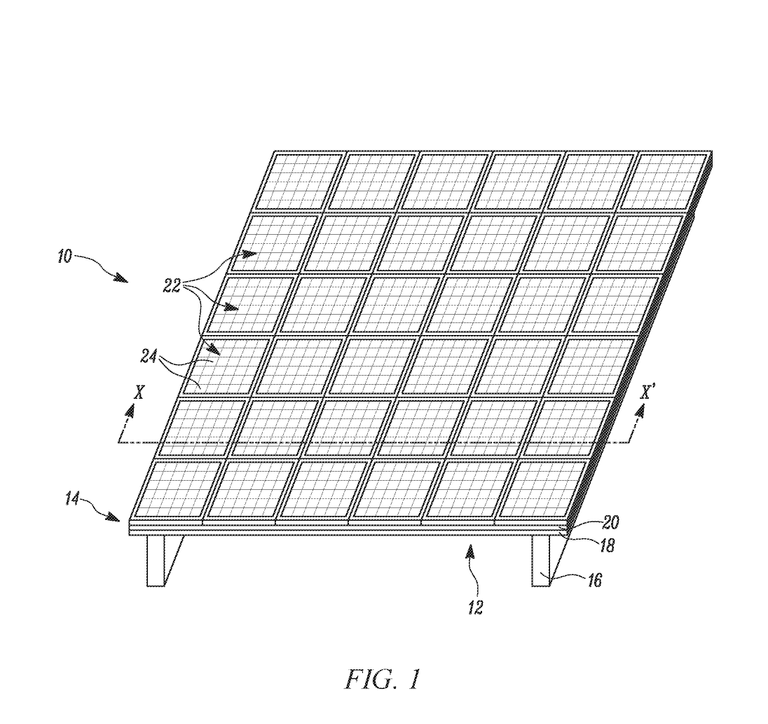

FIG. 1 illustrates a perspective view of a solar panel set 10 mounted at a target location 12. The target location 12 may be understood as a location at which the solar panel set 10 can be mounted to supply solar power to, but not limited to, roof of a machine (not shown) or a plank at a work site. The machine may include, but is not limited to, a solar powered furnace and a solar vehicle. Further, the target location 12 includes a support member 16, a roof 18 supported on the support member 16, and a roof shingle 20 coupled to the roof 18. Although a single layer of roof shingle 20 is illustrated in FIG. 1, it will be understood that multiple roof shingles 20 may be mounted on the roof 18. The support member 16 may be, but is not limited to, a truss and a rafter. The roof 18 may be made of a plywood sheet, an oriented strand board (OSB), or a sheet metal. The roof shingle 20 may be made of various materials, such as wood, slate, flagstone, fiber, cement, and composite material. The support member 16, the roof 18, and the roof shingle 20 are fastened to each other.

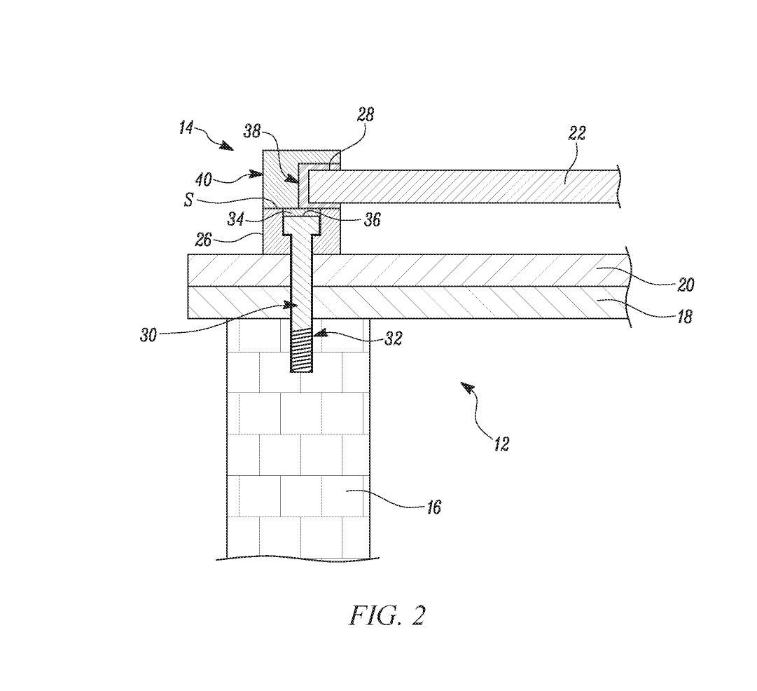

Further, the solar panel set 10 includes a plurality of solar panels 22. Number of solar panels 22 to be disposed at the target location 12 may vary based on a surface area of the target location 12 and power required at a target application. Each solar panel 22 is rigidly mounted on the roof shingle 20 with aid of the anti-theft mounting apparatus 14, which will be described in detail with reference to FIG. 2. The solar panel 22 has a rectangular structure. The solar panel 22 includes a plurality of solar modules 24. The number of solar modules 24 accommodated in the solar panel 22 may vary based on dimensional characteristics of the solar panel 22. The dimensional characteristics may include, but are not limited to, a length and a width of the solar panel 22.

FIG. 2 illustrates a partial sectional view of the solar panel set 10 of FIG. 1 taken along a line X-X′. In particular, FIG. 2 illustrates a portion of a cross-section of the solar panel 22. The anti-theft mounting apparatus 14 includes a base layer 26 of cementitious composite disposed on the roof shingle 20. In one example, the base layer 26 of is disposed on the target location 12 in a semi-solid phase. The base layer 26 is uniformly distributed on the roof shingle 20 in a manner, such that the base layer 26 delineates a rectangular profile similar to a profile of a periphery 28 of the solar panel 22.

The anti-theft mounting apparatus 14 further includes a fastening member 30 for fastening the base layer 26 to the target location 12, and specifically, to the roof shingles 20 and the roof 18. Once the base layer 26 is disposed on the roof shingle 20, a hole 32 is drilled into the roof shingle 20, the roof 18, and the support member 16 after a predefined time interval. The base layer 26 is allowed to cure to a desired phase during the predefined time interval. Subsequently, a counter bore 34 may be formed in the base layer 26 to accommodate a head portion 35 of the fastening member 30, as shown in FIG. 2. In one example, the fastening member 30 may be one of, but is not limited to, an anchor bolt, a rivet, a threaded fastener, a threaded rod, and a screw anchor. It will be understood to a person skilled in the art that a countersink or any other coaxial cutout may be formed instead of the counter bore 34 to accommodate the head portion 35 of the fastening member 30. Further, the fastening member 30 is fastened into the hole 32 in a manner, such that a top surface 36 of the head portion 35 of the fastening member 30 is disposed either along a surface ‘S’ of the base layer 26 or at a distance below the surface ‘S’.

The anti-theft mounting apparatus 14 further includes a damping member 38 disposed along a periphery 28 of the solar panel 22. The damping member 38 may be disposed in a manner to cover the periphery 28 of the solar panel 22. For instance, the damping member 38 may be embodied as a rectangular cover member having a C-shaped cross-section, as shown in FIG. 2. Such cross-section of the damping member 38 may completely cover thickness of the solar panel 22 throughout the periphery 28 of the solar panel 22. In one example, the damping member 38 may be one of, but is not limited to, a rubber lining and an elastomeric material. Further, the damping member 38 may be a single member capable of being stretched. With such capability, the damping member 38 may be stretched across the length and the width of the solar panel 22 to cover the periphery 28 of the solar panel 22. In another instance, a slit may be provided in the damping member 38. Owing to the presence of the slit, ends of the damping member 38 at the slit may be stretched and, subsequently, the damping member 38 may be positioned along the periphery 28 of the solar panel 22. Accordingly, when the damping member 38 is released after positioning along the periphery 28, the ends of the damping member 38 defining the slit abuts each other by virtue of an elasticity of the damping member 38. The damping member 38 is provided to secure the solar panel 22 by preventing any shock that may otherwise be incident on the periphery 28 of the solar panel 22.

Further, the solar panel 22 along with the damping member 38 is disposed on the base layer 26 of the cementitious composite, where the damping member 38 abuts the base layer 26 of the cementitious composite. Although the damping member 38 described herein includes a C-shaped cross-section, it will be understood that a structure and cross-section of the damping member 38 may be varied to at least partially cover the periphery 28 of the solar panel 22, albeit with few variations known to the person skilled in the art. Furthermore, the anti-theft mounting apparatus 14 includes a top layer 40 disposed on the damping member 38 and along the periphery 28 of the solar panel 22. In an example, the top layer 40 may be identical in composition and phase with respect to the base layer 26. In such a condition, the top layer 40 binds with the base layer 26 to form an anti-theft coupling. For instance, the semi-solid phase of the top layer 40 and the base layer 26 may facilitate the binding of the two layers.

In another example, the composition of the base layer 26 and the top layer 40 may be different, but still being capable of binding with the other layer. In such a case, the top layer 40 and the base layer 26 forms a compound layer after solidification. The compound layer thus formed due to binding of the top layer 40 and the base layer 26 forms the anti-theft coupling that rigidly secures the solar panel 22 at the target location 12. In an example, the top layer 40 may be deposited on the roof shingle 20 with the aid of a depositing gun. As such, care may be taken to deposit the top layer 40 along the periphery 28 of the solar panel 22, such that the deposition of the top layer 40 does not extend beyond the damping member 38. In other words, the damping member 38 may indicate an extent to which the top layer 40 can be deposited along the periphery 28 of the solar panel 22. In addition, the top layer 40 also covers the top surface 36 of the head portion 35 of the fastening member 30 in cases where the top surface 36 is disposed below the surface ‘S’ of the base layer 26.

### INDUSTRIAL APPLICABILITY

The present disclosure relates to the anti-theft mounting apparatus 14 for mounting the solar panel 22 at the target location 12. The anti-theft coupling formed due to binding of the top layer 40 and the base layer 26, ensures secure mounting of the solar panel 22 at the target location 12. In other words, the anti-theft mounting apparatus 14 aids in efficient mounting of the solar panel 22 to the target location 12, such that any misappropriation or attempt to forcefully un-mount the solar panel 22 from the target location 12 would cause structural damage to the solar panel 22, thereby rendering the solar panel 22 non-functional. In addition, the anti-theft mounting apparatus 14 of the present disclosure offers a simple, an effective, and a cost effective coupling device for securing the solar panel 22 at the target location 12.

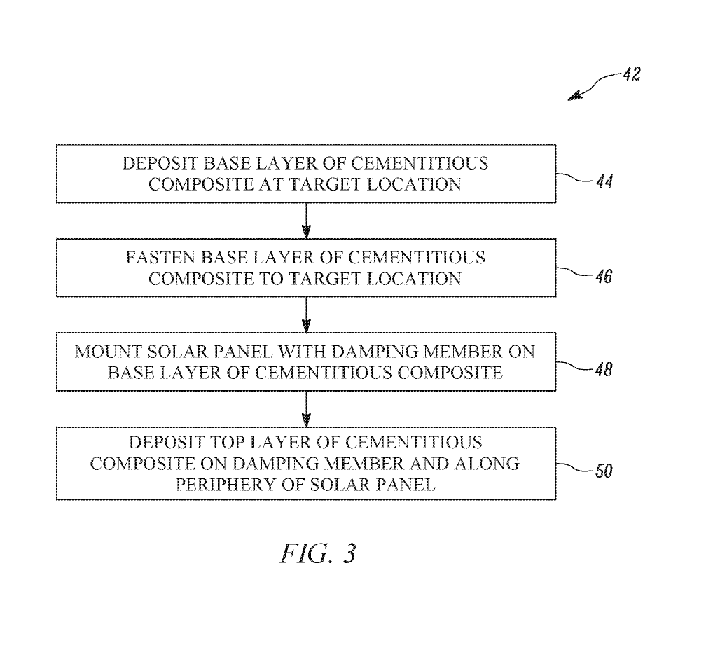

Further, the present disclosure also provides a method 42 for mounting the solar panel 22 or the solar panel set 10 at the target location 12. FIG. 3 illustrates a flowchart of the method 42. The steps in which the method 42 is described are not intended to be construed as a limitation, and any number of steps can be combined in any order to implement the method 42.

For the purpose of illustration, various steps of the method 42 are described in conjunction with FIGS. 1 and 2 of the present disclosure. At step 44, the method 42 includes depositing the base layer 26 on the roof shingle 20 at the target location 12. At step 46, the method 42 includes fastening the base layer 26 to the target location 12. The base layer 26 is fastened to the target location 12 by the fastening member 30. More specifically, the base layer 26 is fastened to the roof shingles 20, the roof 18, and the support member 16 by the fastening member 30. At step 48, the method 42 includes mounting the solar panel 22 on the base layer 26. The solar panel 22 has the periphery 28 that is concealed by the damping member 38.

At step 50, the method 42 includes depositing the top layer 40 on the damping member 38 and along the periphery 28 of the solar panel 22. The top layer 40 binds with the base layer 26 in the semi-solid phase. The top layer 40 and the base layer 26 binds with each other to form the compound layer of cementitious composite. The compound layer of cementitious composite solidifies to form the anti-theft coupling that rigidly secures the solar panel 22 at the target location 12.

While aspects of the present disclosure have been particularly shown and described with reference to the embodiments above, it will be understood by those skilled in the art that various additional embodiments may be contemplated by the modification of the disclosed remote operating station without departing from the spirit and scope of what is disclosed. Such embodiments should be understood to fall within the scope of the present disclosure as determined based upon the claims and any equivalents thereof.

What is claimed is:

1. An anti-theft mounting apparatus for a solar panel, the anti-theft mounting apparatus comprising:
a base layer of cementitious composite disposed at a target location;
a fastening member for fastening the base layer of composite to the target location;
a damping member disposed on the base layer of cementitious composite and along a periphery of the solar panel; and
a top layer of cementitious composite disposed on the damping member and along the periphery of the solar panel, wherein the top layer of cementitious composite binds with the base layer of cementitious composite to form an anti-theft coupling.
